(19) United States
(12) Patent Application Publication
(10) Pub. No.: US 2020/0407616 A1
(43) Pub. Date: Dec. 31, 2020

(54) Method For Producing A Ceramic Material For Thermal Energy Storage

(71) Applicants: OCP SA, Casablanca (MA); Prayon, Engis (BE); Association Pour La Recherche Developpement Des Methodes Et Processus Industriels - A.R.M.I.N.E.S., Paris (FR)

(72) Inventors: Rachid Boulif, El Jadida (MA); Driss Dhiba, Casablanca (MA); Nawal Semlal, El Jadida (MA); Alain Germeau, Auderghem (BE); Claudia Toussaint, Andenne (BE); Ange Nzihou, Paris (FR); Doan Pham Minh, Paris (FR); Abdoul Razac Sane, Paris (FR)

(73) Assignees: OCP SA, Casablanca (MA); Prayon, Engis (BE); Association Pour La Recherche Developpement Des Methodes Et Processus Industriels - A.R.M.I.N.E.S., Paris (FR)

(21) Appl. No.: 16/976,649

(22) PCT Filed: Feb. 28, 2019
(86) PCT No.: PCT/FR2019/050459

§ 371 Date: Aug. 28, 2020

(30) Foreign Application Priority Data
Mar. 1, 2018 (FR) 1851786

(51) Int. Cl. C09K 5/14; C04B 33/04; C04B 33/13; C04B 33/30; C04B 33/32; B28B 1/00; F28D 20/02

(52) U.S. Cl. CPC C09K 5/14; C04B 33/04; C04B 33/131; C04B 33/30; C04B 33/32; B28B 1/008; B28B 3/20; C04B 2235/349; C04B 2235/3418; C04B 2235/447; C04B 2235/5427; C04B 2235/9607; F28D 20/02

(57) ABSTRACT

A method for manufacturing a ceramic material for thermal energy storage, includes producing a mixture of at least particles of clay and particles of natural and/or synthetic phosphate, and water, the mixture comprising between 0.5% and 40% by weight of phosphate compared to the weight of the mixture with the exception of water, and shaping and firing of the mixture to obtain the ceramic material. A ceramic material for thermal energy storage includes: a matrix of clay and, if appropriate, sand, and particles of a natural and/or synthetic phosphate dispersed in the matrix, the ceramic material comprising between 0.5% and 40% by weight of phosphate compared to the weight of the ceramic material.

A method for storing thermal energy in the ceramic material includes: placing a heat transfer fluid in contact with the ceramic material, to transfer heat from the heat transfer fluid to the ceramic material in a charge phase, and to transfer heat from the ceramic material to the heat transfer fluid in a discharge phase.

### FIELD OF THE INVENTION

The present invention relates to a thermal storage material, more specifically for the storage of sensible heat, as well as a method for manufacturing such a material, and a thermal storage method implementing said material.

### PRIOR ART

Thermal storage consists in storing heat in a medium for later use. This medium is composed of a specific material called thermal storage material.

Three thermal energy storage methods exist: storage of sensible heat, storage of latent heat and storage by thermochemical process [1]. As indicated above, the present invention relates to materials for the storage of sensible heat.

The storage of sensible heat consists in a simple rise in the temperature of the storage material. The amount of heat stored by the material is given by the following equation:

Q=∫_{T}_{ᵢ}^{T}^{^{f}}mCₚ(T)dT (1)

with Q the amount of heat stored (J); Tᵢ and T_{f} the initial and final storage temperatures (K), respectively; m the weight of the storage material (g); Cₚ(T) the calorific value of the storage material (J/g·K).

A material for storing sensible heat may be a liquid or a solid.

The case of liquid materials has experienced industrial success with molten salts based on alkali nitrates which are used in CSP (Concentrated Solar Power) plants. Several CSP plants are currently in operation [2]-[3]. However, molten salts have weaknesses linked to their important use as fertilisers in agriculture, with a risk of complete chemical decomposition above 565° C., and to their high price.

Hence, solid materials such as concrete have been tested by the German Aerospace Centre, in German Deutsches Zentrum für Luft—and Raumfahrt, better known by the abbreviation DLR [4]. Concrete is available in industrial quantities at competitive cost. However, its use is limited to around 400° C. to avoid mechanical damage.

The development of materials that are more stable, more efficient and more advantageous economically thus remains necessary.

### DESCRIPTION OF THE INVENTION

An aim of the invention is thus to design a material for thermal storage which can be easily shaped by an industrial method, be available in industrial quantities, and be used over a wide temperature range, being capable of going up to 1100° C.

For this purpose, the invention proposes a method for manufacturing a ceramic material for thermal energy storage, characterised in that it comprises the production of a mixture of at least particles of clay, particles of natural and/or synthetic phosphate, and water, said mixture comprising between 0.5% and 40% by weight of phosphate compared to the weight of the mixture with the exception of water. The method also comprises the steps of shaping and firing the mixture to obtain the ceramic material.

Said natural and/or synthetic phosphate may notably comprise hydroxyapatite.

In a particularly advantageous manner, the mixture comprises between 4% and 5% by weight of phosphate. In the remainder of the text, contents by weight are calculated compared to the total weight of the mixture excluding water.

Said mixture advantageously comprises between 50 and 90% by weight of clay, preferably between 60 and 80%.

Preferably, the average size of the clay and phosphate particles is less than 1 mm.

According to an embodiment, the mixture further comprises up to 40% by weight of sand particles, preferably between 10 and 30% by weight.

The average size of the sand particles is advantageously less than 1.5 mm.

Said method advantageously comprises the shaping of the ceramic material by one of the following techniques: extrusion, granulation, moulding, compacting or pressing of the mixture.

The method may comprise, after the shaping step, the drying of the ceramic material at a temperature less than or equal to 105° C.

The method may comprise, after the drying step, the firing of the ceramic material at a temperature comprised between 800 and 1200° C., preferably between 900 and 1150° C.

Another object of the invention relates to a ceramic material for thermal energy storage, capable of being obtained by the method such as described above. Said ceramic material comprises a matrix of clay and, if appropriate, sand, and particles of natural and/or synthetic phosphate dispersed in said matrix, said ceramic material comprising between 0.5% and 40% by weight of phosphate compared to the weight of the ceramic material.

Advantageously, the ceramic material is in the form of a cylinder, a sphere, a cube, a spiral, a flat plate, a corrugated plate, a hollow brick or a Raschig ring.

Another object of the invention relates to a thermal energy storage method implementing such a material. Said method comprises placing a heat transfer fluid in contact with the ceramic material described above, so as to transfer heat from the heat transfer fluid to the ceramic material in a charge phase, and to transfer heat from the ceramic material to the heat transfer fluid in a discharge phase.

For the implementation of said method, the ceramic material is contained in a tank. Said tank is advantageously formed of at least one thermally insulating material.

The heat transfer fluid is typically selected from air, water vapour, an oil or a molten salt.

During the charge phase and/or the discharge phase, the heat transfer fluid is at a temperature comprised between 20 and 1100° C.

Finally, the invention relates to a device for the implementation of said energy storage method. Said device comprises a tank containing the ceramic material and a heat transfer fluid circulation circuit in fluidic connection with the tank so as to place said heat transfer fluid in contact with the ceramic material.

### BRIEF DESCRIPTION OF THE FIGURES

Other characteristics and advantages of the invention will become clear from the detailed description that follows, with reference to the appended drawings in which:

FIG. 1 is a mapping of the elements present in an earthenware ceramic without addition of phosphate (referenced Ceram1 in Table 1);

FIG. 2 is a mapping of the elements present in a ceramic containing 16.7% of CP and fired at 1100° C. (referenced Ceram8 in Table 1);

FIG. 3 is a mapping of the elements present in a ceramic containing 16.7% of PN and fired at 1100° C. (referenced Ceram28 in Table 1);

FIG. 4 illustrates the thermal conductivity measured by the Hot Disk method for ceramics containing CP and fired at different temperatures;

FIG. 5 illustrates the thermal conductivity measured by the Hot Disk method for ceramics containing PN and fired at different temperatures;

FIG. 6 illustrates the thermal conductivity measured dynamically on ceramics: without phosphate (Ceram1); with 4.7% by weight of CP (Ceram8); with 5% by weight of PN (Ceram34);

FIG. 7 illustrates the flexural tensile strength of ceramics with or without addition of CP and fired at different temperatures;

FIG. 8 illustrates the flexural tensile strength of ceramics with or without addition of PN and fired at different temperatures;

FIG. 9 represents the mechanical strength (Young's modulus) measured dynamically by acoustic resonance on a ceramic without phosphate (Ceram1) or with the addition of 4.7% by weight of CP (Ceram8);

FIG. 10 illustrates the calorific value (specific heat) measured dynamically by a DSC 404 F1 Pegasus™ on a ceramic without phosphate (Ceram1), with the addition of 4.7% by weight of CP (Ceram8), or with the addition of 5% by weight of PN (Ceram34);

FIG. 11 illustrates the flexural tensile strength of ceramics prepared with different sizes (d₅₀) of particles of PN and fired at different temperatures;

FIG. 12 illustrates a thermogravimetric analysis of ceramics containing 4.7% by weight of CP (Ceram8) or 5% by weight of PN (Ceram34) (the left Y-axis is the variation in weight of the material (in %), the right Y-axis is the temperature (in ° C.), and the X-axis is time (in min);

FIG. 13 is a schematic diagram of the tank for storing sensible heat used during the charge phase (a) and the discharge phase (b).

FIG. 14 relates to the charge phase during the sensible heat storage test with the material Ceram9 at moderate temperatures (T_{H} around 340° C.): (a) evolution of the axial temperature as a function of the length of the storage tank; (b) input (T1) and output (T2) temperature and level of charge (η_{chg}) as a function of charge time;

FIG. 15 relates to the discharge phase during the sensible heat storage test with the material Ceram9 at moderately high temperatures (T_{H} around 340-343° C.): (a) evolution of the axial temperature as a function of the length of the storage tank; (b) input (T1) and output (T2) temperature and level of discharge (η_{dis}) as a function of discharge time;

FIG. 16 relates to the charge phase during the sensible heat storage test with the material Ceram9 at moderately high temperatures (T_{H} around 520° C.): (a) evolution of the axial temperature as a function of the length of the storage tank; (b) input (T1) and output (T2) temperature and level of charge (η_{chg}) as a function of charge time;

FIG. 17 relates to the discharge phase during the sensible heat storage test with the material Ceram9 at moderately high temperatures (T_{H} around 520° C.): (a) evolution of the axial temperature as a function of the length of the storage tank; (b) input (T1) and output (T2) temperature and level of discharge (η_{dis}) as a function of charge time;

FIG. 18 relates to the charge phase during the sensible heat storage test with the material Ceram9 at high temperatures (T_{H} around 760° C.): (a) evolution of the axial temperature as a function of the length of the storage tank; (b) input (T1) and output (T2) temperature and level of charge (η_{chg}) as a function of charge time;

FIG. 19 relates to the discharge phase during the sensible heat storage test with the material Ceram9 at high temperatures (T_{H} around 760° C.): (a) evolution of the axial temperature as a function of the length of the storage tank; (b) input (T1) and output (T2) temperature and level of discharge (η_{dis}) as a function of discharge time;

FIG. 20 relates to the charge phase during the sensible heat storage test with the material Ceram35 at moderate temperatures (T_{H} around 350° C.): (a) evolution of the axial temperature as a function of the length of the storage tank; (b) input (T1) and output (T2) temperature and level of charge (η_{chg}) as a function of charge time;

FIG. 21 relates to the discharge phase during the sensible heat storage test with the material Ceram35 at moderate temperatures (T_{H} around 350° C.): (a) evolution of the axial temperature as a function of the length of the storage tank; (b) input (T1) and output (T2) temperature and level of discharge (η_{dis}) as a function of discharge time;

FIG. 22 relates to the charge phase during the sensible heat storage test with the material Ceram35 at moderately high temperatures (T_{H} around 580° C.): (a) evolution of the axial temperature as a function of the length of the storage tank; (b) input (T1) and output (T2) temperature and level of charge (η_{chg}) as a function of charge time;

FIG. 23 relates to the discharge phase during the sensible heat storage test with the material MC/PN at moderately high temperatures (T_{H} around 580° C.): (a) evolution of the axial temperature as a function of the length of the storage tank; (b) input (T1) and output (T2) temperature and level of discharge (η_{dis}) as a function of discharge time;

FIG. 24 relates to the charge phase during the sensible heat storage test with the material Ceram35 at high temperatures (T_{H} around 850° C.): (a) evolution of the axial temperature as a function of the length of the storage tank; (b) input (T1) and output (T2) temperature and level of charge (η_{chg}) as a function of charge time;

FIG. 25 relates to the discharge phase during the sensible heat storage test with the material MC/PN at high temperatures (T_{H} around 850° C.): (a) evolution of the axial temperature as a function of the length of the storage tank; (b) input (T1) and output (T2) temperature and level of discharge (η_{dis}) as a function of discharge time.

### DETAILED DESCRIPTION OF EMBODIMENTS OF THE INVENTION

The inventors have demonstrated the possibility of obtaining a ceramic material having excellent aptitude to thermal energy storage by mixing particles of clay, sand, phosphate, and water. Said mixture may in fact have a plasticity favourable for the implementation of different techniques, such as extrusion, granulation, moulding or pressing, which enable the ceramic material to be shaped into a form suitable for thermal energy storage.

In the present text, ceramic is taken to mean a material in solid form having undergone a firing cycle.

Conventional earthenware ceramics are manufactured from a mixture of clay, sand and water.

Clays have a structure in the form of lamina enabling water molecules to be interposed between said lamina. This confers on them a plastic property and offers them the possibility of being used as plastifiers or structuring agents. The plastic property of clays is a decisive parameter for the shaping of earthenware ceramic materials.

Globally, clays exist in several mineralogical forms grouped together into four families [5]. They are kaolinites (Al₂Si₂O₅(OH)₄), illites (K(Al,Mg,Fe)₂(Si,Al)₄O₁₀[(OH)₂,H₂O], smectites ((Ca,Na)_{0.3} (Al,Mg,Fe)₂(Si,Al)₄O₁₀(OH)₂,nH₂O) and chlorites.

Clay is a natural material, available in industrial quantities with good plasticity compared to several other binders such as polyvinyl alcohol, gelatine, polyethylene glycol or polyacrylic acid, which are used in different industrial methods.

Sands are inert materials without plasticity which are essentially composed of quartz and other minerals such as feldspaths and micas. In the earthenware industry, sands are used as tempers to facilitate the drying step. Their use makes it possible to obtain in the clayey matrix a skeleton conducive to the dehydration of clayey minerals. This prevents important shrinkages which can lead to fissuring of the materials.

An important family of phosphates exists, which are either natural (phosphate ores), or synthetic. They are formed from phosphate anions (orthophosphate (PO₄)³⁻) and metal cations M where M may be an alkali, an alkaline-earth or any metal of the periodic table of elements. This diversity makes it possible to obtain phosphated products with highly varied properties.

The phosphate used in the present invention may be a natural phosphate (that is to say a phosphate ore) or a synthetic phosphate such as hydroxyapatite (Ca₁₀(PO₄)₆(OH)₂), or even a mixture of these two types of phosphate.

The presence of a phosphate incorporated within the matrix of clay (which further optionally contains sand) makes it possible to improve the physical, thermal and mechanical properties of the ceramic material, notably the density, the thermal conductivity, the calorific value or the mechanical stability.

According to an advantageous embodiment, extrusion is a simple and well-mastered shaping technique for the production on a large industrial scale of ceramic materials intended for thermal energy storage, and which is suited for the mixture described above. Extrusion consists in passing the mixture, at a controlled pressure, through a double helix, then a worm screw before making it come out through a die in monolithic form. This technique makes it possible to obtain ceramic materials of different shapes: cylindrical, alveolar, flat plate, corrugated plate, hollow brick, etc. Those skilled in the art choose the size and the shape of the ceramic materials in order to control heat exchanges during the storage and the de-storage of sensible heat.

However, this embodiment is not limiting and the mixture may be shaped by other techniques such as granulation, moulding, compacting or pressing. For example, granulation is advantageous in that it makes it possible to obtain materials of spherical shape of different sizes.

Generally speaking, the ceramic material may have the following shapes: cylinder, sphere, cube, spiral, flat plate, corrugated plate, hollow brick, Raschig ring (non-limiting list). Those skilled in the art will choose the shaping technique as a function of the desired shape.

The composition of the mixture is controlled to have good plasticity with a view to the shaping step, and to obtain physical, thermal and mechanical properties appropriate for the storage of sensible heat.

For this purpose, the added phosphate content may reach up to 40% by weight (i.e. 17% by weight of P₂O₅), and is comprised between 0.5% and 40%, preferably comprised between 4% and 5% by weight (in the present text, the reference weight is that of the dry mixture (not including added water)). In all cases, the phosphate content is not zero. A phosphate content of at least 0.5% by weight makes it possible to improve significantly the thermal conductivity and the mechanical strength of ceramics. A phosphate content less than 40% by weight makes it possible to guarantee good plasticity of the mixture of clay, phosphate, and water and facilitates the later shaping thereof.

The sand content may vary between 0 and 40% by weight, preferably between 10 and 30%. The sand content depends on the nature of the clayey mixture (source deposit). Phosphate may replace all or part of the sand. Thus, it is possible to be free of sand in the mixture for example when important amounts of phosphate are added (of the order of 20 to 40%). In the remainder of the text, for the sake of brevity, the term “clay-sand matrix” covers a possible absence of sand.

The clay content may vary between 50 and 90% by weight, preferably between 60 and 80%.

The water content is adjusted in such a way as to confer on the mixture a pasty consistency, the viscosity of which is suited to the retained shaping technique. This water will be eliminated in the course of later thermal treatments (namely drying and firing).

The size of the particles of the mixture is also controlled because it influences the final properties of the ceramic material. Size is taken to mean in the present text the diameter of a sphere having the same volume as the considered particle; in the case of a spherical particle, the size is the diameter of the particle. In so far as the particles generally have a variable size within a determined range, the median size, noted d₅₀, is considered that is to say the size for which 50% of the particles have a smaller size and 50% of the particles have a larger size.

Thus, the size d₅₀ of the phosphate particles is advantageously less than 1 mm; that of the clay and the sand is preferably less than 1 and 1.5 mm, respectively.

After the shaping step, thermal treatments by drying and by firing are applied.

Drying is advantageously carried out in stages, at different temperatures which do not exceed 105° C. According to a preferred embodiment, the drying comprises successively a first stage at 25° C., a second stage at 45° C., a third stage at 70° C. and a fourth stage at 105° C. Each stage is applied for a determined duration which may be identical or different from one stage to the next. Preferably, the duration of each stage is 24 h. Such a drying by stages makes it possible to evacuate water progressively and thus to avoid generating strains in the material. At the end of drying, the material does not in principle contain any more water.

Firing is carried out after the drying step. It may be carried out in a static oven or in a tunnel oven. A moderate temperature rise ramp is applied, preferably 5° C./min, in order to avoid generating strains in the material. The firing temperature applied may vary between 800 and 1200° C., preferably between 900 and 1150° C. The stage at the firing temperature is comprised between 0.5 and 5 h, preferably 1 h.

At the end of the drying step, the ceramic material has a clay-sand matrix in which are dispersed phosphate particles.

As the experimental results described hereafter demonstrate, said ceramic material has good thermal energy storage properties.

The ceramic material may thus be used for the implementation of a thermal energy storage method. For this purpose, the ceramic material is placed in contact with a heat transfer fluid in such a way as to enable an exchange of heat.
in a charge phase, the heat transfer fluid is at a high temperature, greater than that of the ceramic material; heat is transferred from the heat transfer fluid to the ceramic material, and stored up in said material for the desired storage duration;
in a discharge phase, the heat transfer fluid is at a low temperature, less than that of the ceramic material; heat stored in the ceramic material is then transferred to the heat transfer fluid.

The heat thus discharged may be used for the generation of electricity, for the heating of a room, or for any other use.

The heat transfer fluid may be a gas or a liquid. For example, but in a non-limiting manner, the heat transfer fluid may be air, water vapour, an oil or a molten salt.

For the implementation of said thermal storage method, the ceramic material is in the form of a plurality of units which together constitute a packing. The size and shape of these units is chosen to maximise the contact surface with the heat transfer fluid.

Said packing is arranged in a tank which is made of one or more thermally insulating material(s).

The tank is in fluidic connection with a heat transfer fluid circuit. Advantageously, the tank has a heat transfer fluid inlet and outlet, arranged with respect to one another in such a way as to ensure as large a contact surface as possible between the heat transfer fluid and the ceramic material which composes the packing. For example, the tank has a cylindrical shape extending horizontally, and a heat transfer fluid inlet and outlet are each arranged at one end of the tank.

Depending on the charge or discharge phase, the direction of circulation of the heat transfer fluid within the tank may be reversed: the terms “inlet” and “outlet” are thus relative.

Such a device may notably be put in place in a concentrated solar power plant, but also in any installation requiring sensible energy storage.

### Experimental Results

Several ceramic materials were manufactured by extrusion as defined in Table 1. The studied parameters were: the composition of the mixture, the size of the phosphate particles, and the firing temperature. As indicated above, drying was carried out at 25, 45, 70 and 105° C. with a 24 h stage at each temperature. The materials not containing phosphate (Ceram0, Ceram1, Ceram2) are considered as reference samples.

TABLE 1
List of materials prepared and associated characteristics

| | Clay, | Sand, | CP, | PN, | | Firing |
|---|---|---|---|---|---|---|
| | % by | % by | % by | % by | d₅₀^{PN}, | temperature, |
| | weight | weight | weight | weight | μm | ° C. |
| Ceram0 | 80 | 20 | 0 | 0 | — | 920 |
| Ceram1 | 80 | 20 | 0 | 0 | — | 1100 |
| Ceram2 | 80 | 20 | 0 | 0 | — | 1140 |
| Ceram3 | 79.6 | 19.9 | 0.5 | 0 | — | 920 |
| Ceram4 | 79.6 | 19.9 | 0.5 | 0 | — | 1100 |
| Ceram5 | 78.40 | 19.6 | 2 | 0 | — | 920 |
| Ceram6 | 78.40 | 19.6 | 2 | 0 | — | 1100 |
| Ceram7 | 76.24 | 19.06 | 4.7 | 0 | — | 920 |
| Ceram8 | 76.24 | 19.06 | 4.7 | 0 | — | 1100 |
| Ceram9 | 76.24 | 19.06 | 4.7 | 0 | — | 1140 |
| Ceram10 | 73.60 | 18.4 | 8 | 0 | — | 920 |
| Ceram11 | 73.60 | 18.4 | 8 | 0 | — | 1100 |
| Ceram12 | 70.40 | 17.6 | 12 | 0 | — | 920 |
| Ceram13 | 70.40 | 17.6 | 12 | 0 | — | 1100 |
| Ceram14 | 66.64 | 16.66 | 16.7 | 0 | — | 920 |
| Ceram15 | 66.64 | 16.66 | 16.7 | 0 | — | 1100 |
| Ceram16 | 66.64 | 16.66 | 16.7 | 0 | — | 1140 |
| Ceram17 | 79.6 | 19.9 | 0 | 0.5 | 100 | 920 |
| Ceram18 | 79.6 | 19.9 | 0 | 0.5 | 100 | 1100 |
| Ceram19 | 78.40 | 19.6 | 0 | 2 | 100 | 920 |
| Ceram20 | 78.40 | 19.6 | 0 | 2 | 100 | 1100 |
| Ceram21 | 76.24 | 19.06 | 0 | 4.7 | 100 | 920 |
| Ceram22 | 76.24 | 19.06 | 0 | 4.7 | 100 | 1100 |
| Ceram23 | 73.60 | 18.4 | 0 | 8 | 100 | 920 |
| Ceram24 | 73.60 | 18.4 | 0 | 8 | 100 | 1100 |
| Ceram25 | 70.40 | 17.6 | 0 | 12 | 100 | 920 |
| Ceram26 | 70.40 | 17.6 | 0 | 12 | 100 | 1100 |
| Ceram27 | 66.64 | 16.66 | 0 | 16.7 | 100 | 920 |
| Ceram28 | 66.64 | 16.66 | 0 | 16.7 | 100 | 1100 |
| Ceram29 | 76.24 | 19.06 | 0 | 4.7 | 70 | 920 |
| Ceram30 | 76.24 | 19.06 | 0 | 4.7 | 70 | 1100 |
| Ceram31 | 76.24 | 19.06 | 0 | 4.7 | 170 | 920 |
| Ceram32 | 76.24 | 19.06 | 0 | 4.7 | 170 | 1100 |
| Ceram33 | 80 | 15 | 0 | 5 | 100 | 920 |
| Ceram34 | 80 | 15 | 0 | 5 | 100 | 1100 |
| Ceram35 | 80 | 15 | 0 | 5 | 100 | 1140 |

In the present text, the acronym CP designates synthetic hydroxyapatite of formula (Ca₁₀(PO₄)₆(OH)₂), of which the size d₅₀ is 5 μm; the acronym PN designates a phosphate ore mainly containing P₂O₅ (30.4%), SiO₂ (3.2%), Na₂O (0.7%), Al₂O₃ (0.5%), MgO (0.4%), Fe₂O₃ (0.3%), K₂O (0.1%) (weight percentages).

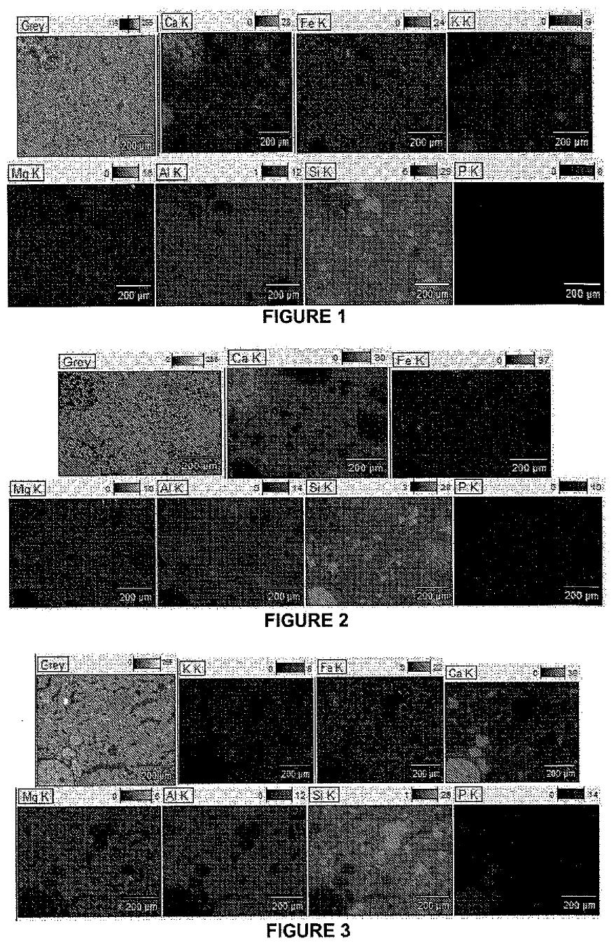

The distribution of major elements present in certain of these ceramics was studied by the SEM-EDX (Scanning Electron Microscopy associated with Energy Dispersive X-ray spectroscopy) technique and the results are shown in FIGS. 1, 2 and 3. In FIG. 1 (for the sample Ceram1) are found the main elements of clay and sand such as Ca, Si, Al, Fe. Phosphorous is only present in trace amounts. Conversely, in FIGS. 2 and 3, phosphorous is indeed present in the ceramics produced with 16.7% by weight of CP or PN. It also appears that phosphorous is distributed in a homogeneous manner in the clay-sand matrix when CP is used whereas it is less homogeneous when PN is used. Indeed, the particles of CP are smaller than those of PN and can thus be inserted more easily into the clay-sand matrix.

Thermal conductivity is an important parameter of ceramic materials for the storage of sensible heat. Indeed, it directly influences the transfer of heat within materials, during the charge and discharge phases.

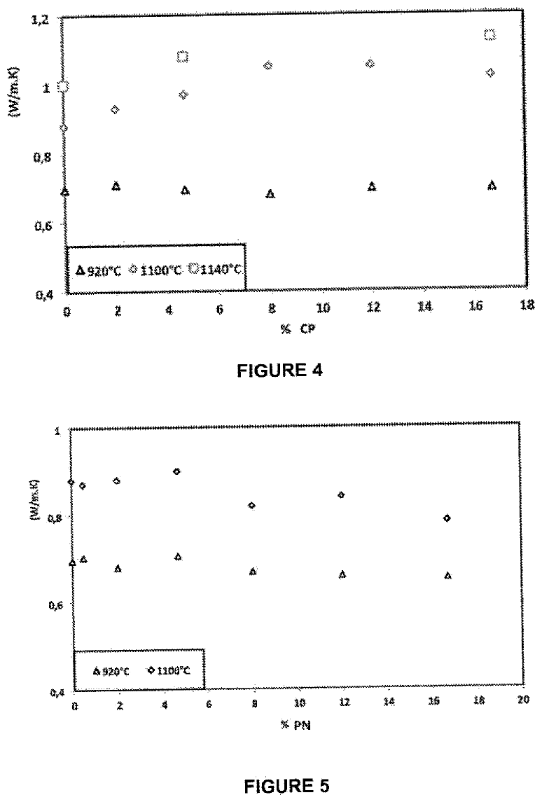

FIGS. 4 and 5 show the evolution of the thermal conductivity as a function of the CP or PN content and the firing temperature. The measurement was carried out by the Hot Disk method using a Kapton (No 5465) type probe. All the measurements were carried out at 25° C. on fired ceramics. Said Hot Disk method is based on the use of a probe placed between the samples to characterise. The samples may be in the form of powder (in this case a sample holder is used) or in monolithic form. The probe is a resistive element acting both as a thin heat source, laterally limited, and as a temperature sensor. It is constituted of a nickel film of 10 μm thickness coated with a film of 25 to 30 μm thickness of Kapton or 100 μm thickness of mica. On the metallic film is drawn a double spiral circuit. During the measurement, the increase in temperature in the sensor is determined with precision by the electrical resistance measurement. This increase in temperature strongly depends on the thermal transport properties of the material. By monitoring this increase in temperature during a short time lapse, it is possible to obtain precise information on the thermal properties of the characterised material.

In general, the addition of phosphate makes it possible to increase the thermal conductivity of conventional earthenware ceramics. This increase may reach up to 20% compared to an earthenware ceramic without phosphate. The thermal conductivity may thus reach that of concrete, which has a conductivity of the order of 1 to 1.2 W/m.K [4]. The fact that the phosphate particles are inserted in the microstructure of the clay-sand matrix makes it possible to reduce the air pockets (porosities) in the structure of said matrix and consequently to limit the resistance to heat travel. The result is an improvement in thermal conductivity. For a phosphate content of 5% by weight, the thermal conductivity increases by around 7% (with PN, fired at 1100° C.) and 11% (with CP, fired at 1100° C.) compared to a ceramic exempt of phosphate. Thus, a phosphate content of at least 0.5% by weight makes it possible to improve significantly the thermal conductivity of ceramics.

Furthermore, whatever the nature of the phosphate, the thermal conductivity increases with the increase in the firing temperature. This is explained by the densification and the sintering of ceramics. Generally speaking, the firing temperature preferably is between 900 to 1150° C.

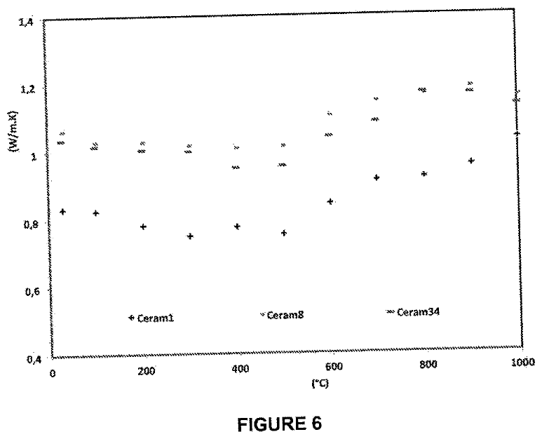

In general, the thermal conductivity varies with the temperature to which the material is exposed. Dynamic measurements between 30 and 1000° C. were performed with a NETSCH LFA 547™ apparatus. The conditions for these measurements were the following: atmosphere: air; heating rate: 5° C./min; temperature: 30-1000° C., flash: 1826 V; stabilisation criterion: linear (baseline). FIG. 6 shows the evolution of the thermal conductivity of ceramics with or without addition of phosphate as a function of temperature. The ceramics were fired beforehand at 1100° C. It is clearly observed that the two ceramics containing phosphate have a thermal conductivity higher than that of the ceramic without phosphate in the studied temperature range. An increase of around 20% is thus observed at 900° C. In this case, there is little influence of the nature of phosphate on the thermal conductivity.

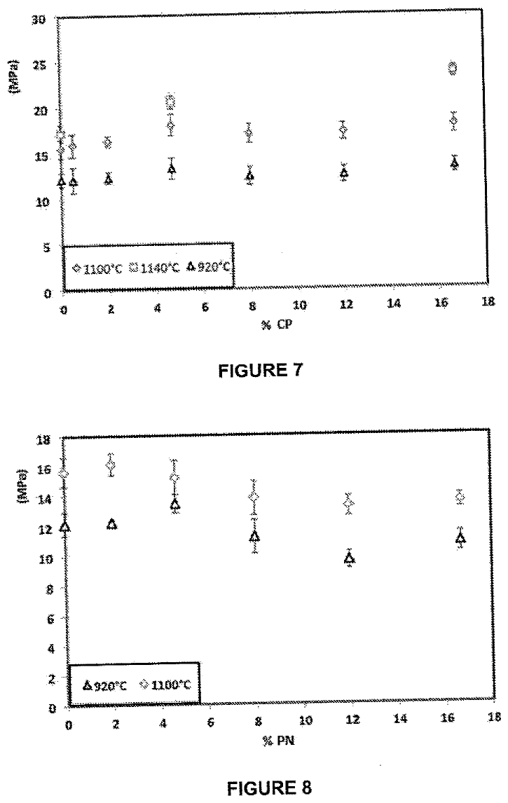

Mechanical strength is also an important parameter of ceramic materials for the storage of sensible heat. FIGS. 7 and 8 show the evolution of the three point flexural tensile strengths of ceramics prepared with or without addition of phosphate. The flexural measurement was carried out at 25° C. on test samples of dimensions 60mm x 15mm x 9mm using an INSTRON™ apparatus. The characteristics of the three point flexural test were the following: speed of displacement: 2 mm/min; cell: 500N; diameter of the support rollers: 5 mm; diameter of the central bearing roller: 5 mm; spacing between the rollers: 40 mm; end of test: breakage of the test sample; temperature: ambient (20° C.). Whatever the firing temperature used, the addition of CP makes it possible to increase the mechanical strength of the ceramics (cf. FIG. 7). In particular, with reference to the graph of FIG. 7, a phosphate content of at least 0.5% by weight makes it possible to significantly improve the mechanical strength of the ceramics. The insertion of fine particles of CP within the clay-sand matrix develops a new microstructure and thus contributes to reinforcing the overall structure by eliminating the pores present in the ceramic initially without phosphate. Conversely, the addition of PN particles, of which the size of the particles is 100 μm, slightly decreases the mechanical strength (cf. FIG. 8).

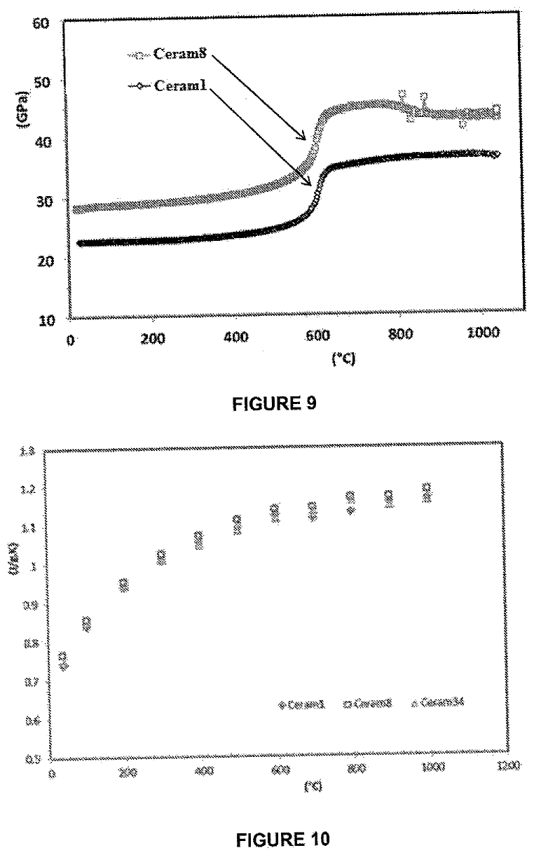

Furthermore, dynamic mechanical strength measurements by acoustic resonance between 30 and 1050° C. were carried out on the ceramics with or without addition of phosphate, which were fired beforehand at 1100° C. These measurements were carried out with a FDA HT650 furnace sold by IMCE™, equipped with a microphone of which the sensitivity was 20 Hz to 50 kHz; the tests were carried out in air, with temperatures varying from 30 to 1050° C., according to a heating rate of 5° C./min. FIG. 9 shows the results obtained. The ceramic containing 4.7% of CP is much more resistant than that without phosphate in the studied temperature range. The difference is estimated at near to 25%.

In sensible heat storage, the specific heat of a material is an important parameter because it is directly proportional to the amount of heat stored (cf. equation (1)). FIG. 10 shows the specific heat of ceramics without phosphate or with the addition of 4.7% by weight of CP and 5% by weight of PN in the temperature range of 30 to 1000° C. The ceramics were fired beforehand at 1100° C. For the three materials, the specific heat increases with increase in temperature. That of the ceramic without phosphate varies from 0.74 J/g.K at 30° C. up to 1.16 J/g.K at 1000° C.; that of the ceramic containing CP varies from 0.77 J/g.K at 30° C. to 1.19 J/g.K at 1000° C.; and that of the ceramic containing PN varies from 0.75 at 30° C. to 1.16J/g.K at 1000° C.

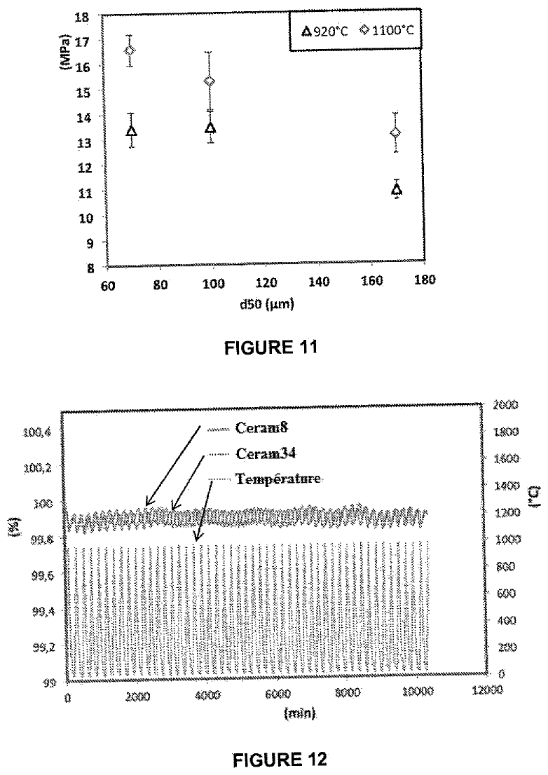

Concerning PN, which is an ore, fine particles were obtained by grinding. FIG. 11 shows the evolution of the flexural tensile strength as a function of the average size of the PN particles. The PN content was set at 4.7% by weight. The smaller the average size of the PN particles, the greater the flexural tensile strength.

In sensible heat storage, the storage material must have good thermal stability during numerous heating and cooling cycles. The thermal stability was studied by thermogravimetric analysis which makes it possible to monitor the evolution of the weight during heating and cooling cycles. The ceramics were fired beforehand at 1100° C. FIG. 12 shows the results obtained with two ceramics containing respectively 4.7% by weight of CP and 5% by weight of PN. The analysis conditions were: heating rate of 10° C./min; atmosphere of air at the flow rate of 100 NmL/min, free cooling, temperature range from 30 to 1000° C. The two ceramics have very good thermal stability in the studied temperature range. The variation in weight is less than 0.2% during the 50 heating and cooling cycles repeated under air. Thus, these ceramics may be used in solar power plants at high temperature such as tower plants with temperatures reaching around 900° C., but also in plants at moderate temperatures such as cylindrical-parabolic plants where temperatures rarely exceed 400° C. These ceramics may also be used to recover heat present in fumes from industrial installations which can reach up to around 1000° C. Generally speaking, they may be in contact with a heat transfer fluid at any temperature going up to 1100° C.

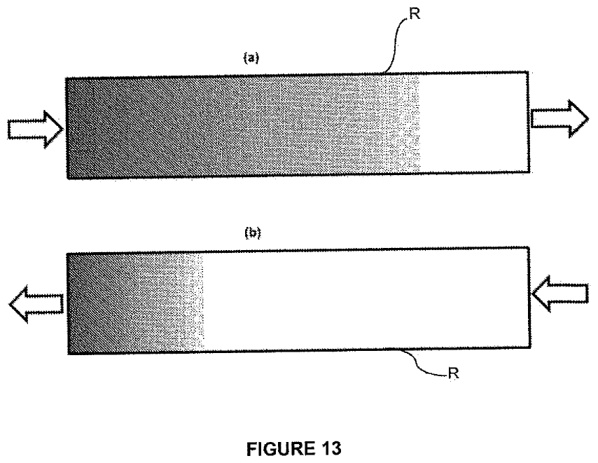

Sensible heat storage experiments were carried out at the pilot scale. A schematic diagram of the pilot used is shown in FIG. 13. It is composed of a storage tank R of dimensions 1.4 m×0.3 m×0.3 m, i.e. a nominal storage volume of 0.126 m³. The tank was made of vermiculite (an insulating and inert material, thickness 0.1 m) and was surrounded by a fibrous rockwool insulating layer (thickness 0.25 m); the whole assembly was finally surrounded by a layer of stainless steel. The tank was installed horizontally. It was equipped with 37 thermocouples to monitor the evolution of the axial temperature all along the vessel. The heat transfer fluid used was air. The arrows indicate the direction of circulation of said fluid in the tank. For the charge phase (a), a blower generated a constant air flow to supply a hot air canon which next supplied the storage tank. This canon was positioned just in front of the inlet of the storage tank. The hot air canon used made it possible to obtain a temperature ranging from 100° C. to 900° C. at the canon outlet. For the discharge phase (b), the blower injected ambient air into the cold part of the vessel to recover the heat initially stored. Two thermocouples, a mass flowmeter and two pressure sensors were also installed to control the flow of the heat transfer fluid during the charge and discharge phases.

To evaluate the performance of the charge and discharge steps, different terms are used which are defined hereafter:
T_{L}: Temperature of the storage material at the start of the charge phase; or low temperature of the heat transfer fluid (air) used for the discharge phase (° C.).
T_{H}: Temperature of the heat transfer fluid (air) at the inlet of the storage tank during the charge phase; or high temperature of the storage material at the start of the discharge phase (° C.).
T_{amb}: Ambient temperature (° C.).
Mass flow rate of air (kg/h).
T_{cut-off/chg}: Temperature threshold at the outlet of the storage tank where the charge phase is stopped.
T_{cut-off/dis}: Temperature threshold at the outlet of the storage tank where the discharge phase is stopped.
β: Temperature threshold coefficient used for the calculation of the temperatures T_{cut-off/chg} and T_{cut-off/dis} according to the following equations:

for a charge: T_{cut-off/chg}=T_{L}β×(T_{H}−T_{L}) (2)

for a discharge: T_{cut-off/dis}=T_{L}+(1−β(3)×(T_{H}−T_{L}) (3)
t_{breakpoint}: Time necessary to reach a value of T_{cut-off/chg} during the charge phase or T_{cut-off/dis} during the discharge phase.
Eₘₐₓ: Amount of thermal energy theoretically calculated by equation (1) between T_{L} and T_{H} (kWh).
E_{chg}: Amount of thermal energy stored in the storage material during the charge phase where the temperature at the outlet of the storage tank is less than T_{cut-off/chg}, E_{chg} is calculated by equation (1) (kWh).
η_{chg}: Level of charge which is the ratio between E_{ch} and Eₘₐₓ (%).
E_{dis}: Amount of thermal energy recovered during the discharge phase where the temperature at the outlet of the storage tank is greater than T_{cut-off/dis}; E_{dis} is calculated by equation (1) (kWh).
n_{dis}: Level of discharge which is the ratio between E_{dis} and E_{chg} (%).
Eᵢₙ: Amount of thermal energy sent into the storage tank during the charge phase (kWh).
Eₒᵤₜ: Amount of thermal energy lost at the outlet of the storage tank during the charge phase, calculated by equation (1) between T_{H} and T_{cut-off/chg} (kWh).
n_{wh}: Thermal losses which are the ratio between Eₒᵤₜ and Eᵢₙ (%).
ε: Porosity of the storage tank filled by cylinders of ceramic material of 15 mm diameter and 40 mm length (%).

Two ceramics were used for the tests at the pilot scale. The first contained 4.7% by weight of CP (Ceram9). The second contained 5% by weight of PN (Ceram35). These ceramics were prepared by the extrusion method and fired at 1140° C. They were of cylindrical shape of 15 mm diameter and 40 mm length. This shape was chosen in order to have a good exchange surface within the thermal storage system. Exchange surface is taken to mean the outer surface of the ceramic material directly in contact with the heat transfer fluid. In addition, this cylindrical shape is easily obtained by the extrusion method. For each experiment, 160 kg of material were needed to fill the storage tank. The porosity of the storage tank filled by these cylinders was around 40%.

### EXAMPLE 1

This test was carried out with the ceramic Ceram9. The charge and discharge conditions are shown in Table 2.

TABLE 2
Test conditions for the material Ceram9 at moderate
temperatures (T_{H} around 340° C.)

| Charge phase | | Discharge phase | |
|---|---|---|---|
| Material | Ceram9 | Material | Ceram9 |
| T_{H} | 343° C. | T_{H} | 340° C. |
| T_{L} | 21° C. | T_{L} | 24° C. |
| T_{amb} | 21° C. | T_{amb} | 24° C. |
| \dot{m} | 74 kg/h | \dot{m} | 74 kg/h |

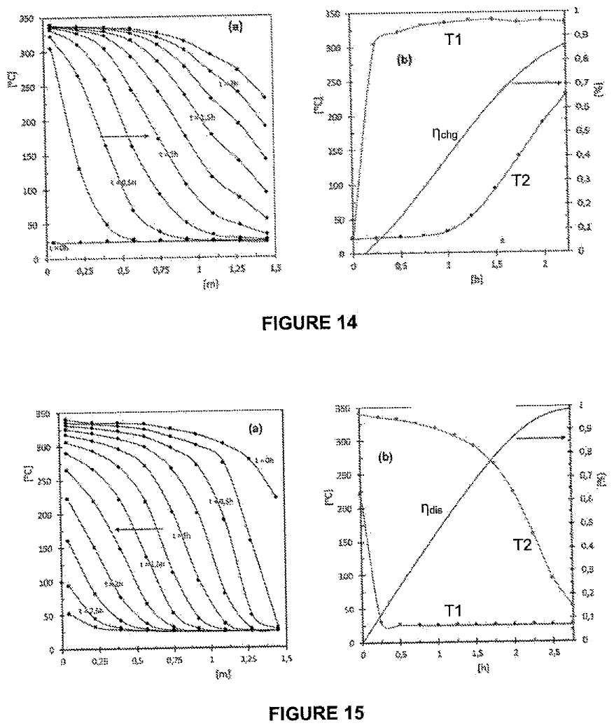

FIG. 14 and Table 3 show the results obtained during the charge phase. In FIG. 14 (a) are shown the axial temperature profiles at different charge times. At a given charge time, the axial temperature drops with the increase in the length of the storage tank. At a given length of storage tank, the axial temperature increases with the increase in the charge time. FIG. 14 (b) shows the evolution of the input (T1) and output (T2) temperature of the storage tank, and the evolution of the level of charge. The input temperature of the tank was rapidly stabilised around T_{H}. The output temperature of the tank was maintained at ambient temperature during around 0.75 h of charge. Consequently, the totality of the heat injected into the vessel was absorbed by the material. Next, this output temperature increased. This indicates that a part of the heat injected comes out of the tank (Eₒᵤₜ, heat not absorbed by the material). Table 3 summarises the results obtained at different T_{cut-off/chg}. With the increase in the charge time (t_{breakpoint}), the level of charge increases and reaches 86.9% after 2.28 h of charge. Consequently, thermal losses increase (increase of NO. However, at a level of charge of 86.9%, thermal losses are only 14.1% which is an excellent result and which demonstrates the efficiency of this material for the storage of heat supplied by the heat transfer fluid.

TABLE 3
Summary of the results obtained at different T_{cut-off/chg}
during the charge phase of the material Ceram9
at moderate temperatures (T_{H} around 340° C.)

| Parameter | Unit | Relevant temperature threshold | | |
|---|---|---|---|---|
| β | — | 0.2 | 0.4 | 0.6 |
| T_{cut-off/chg} | ° C. | 85.4 | 149.8 | 214.2 |
| η_{chg} | % | 67.6 | 79.2 | 86.9 |
| t_{breakpoint} | h | 1.59 | 1.93 | 2.28 |
| η_{wh} | % | 3.5 | 8.1 | 14.1 |

FIG. 15 and Table 4 show the results obtained during the discharge phase. In FIG. 15 (a), are shown the axial temperatures as a function of the discharge time or the length of the storage tank. At a given length of storage tank, an increase in the discharge time leads to a drop in temperature. And at a given discharge time, the temperature drops with the length of the storage tank. In FIG. 15 (b), the increase in discharge time is accompanied by a drop in the output temperature and an increase in the level of discharge. At the end of 2.28 h, the level of discharge reaches 93.6% as specified in Table 4.

TABLE 4
Summary of the results obtained at different T_{cut-off/dis}
during the discharge phase of the material Ceram9
at moderate temperatures (T_{H} around 340° C.)

| Parameter | Unit | Relevant temperature threshold | | |
|---|---|---|---|---|
| β | — | 0.2 | 0.4 | 0.6 |
| T_{cut-off/chg} | ° C. | 276.8 | 213.6 | 150.4 |
| η_{dis} | % | 74.2 | 87 .8 | 93.6 |
| t_{breakpoint} | h | 1.64 | 2.04 | 2.28 |

### EXAMPLE 2

This test was carried out with the same material used for example 1, but at moderately high values of T_{H} (around 520° C.). Table 5 shows the conditions used.

TABLE 5
Test conditions for the material Ceram9 at moderately
high temperatures (T_{H} around 520° C.)

| Charge phase | | | Discharge phase | | |
|---|---|---|---|---|---|
| Material | Ceram9 | | Material | Ceram9 | |
| T_{H} | 528° | C. | T_{H} | 512° | C. |
| T_{L} | 40° | C. | T_{L} | 26° | C. |
| T_{amb} | 22° | C. | T_{amb} | 26° | C. |
| \dot{m} | 53 | kg/h | \dot{m} | 48 | kg/h |

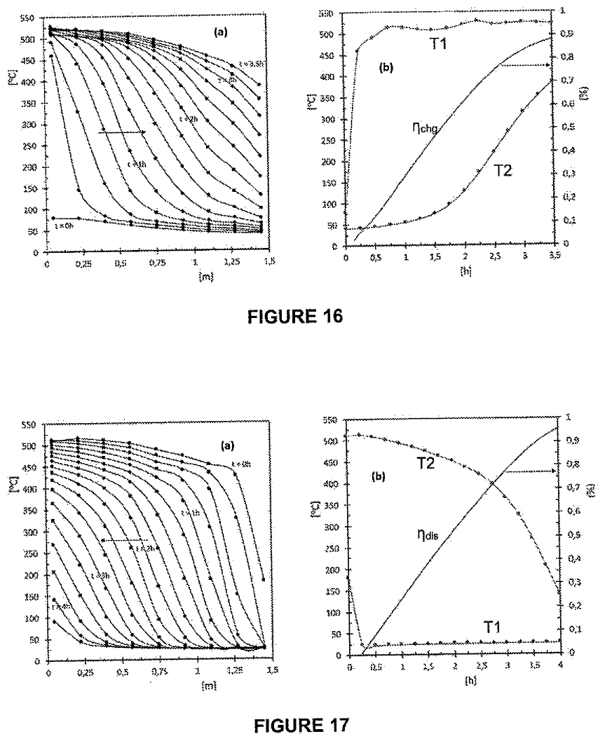

FIG. 16 and Table 6 summarise the results obtained for the charge phase. The input temperature rapidly stabilises between 500 and 528° C. after 30 min of charge. The output temperature remains close to ambient temperature during the 30 first min, then it begins to increase. The level of charge increases with the charge time and reaches 86.4% after 3.27 h. At this level of charge, thermal losses are relatively low (η_{wh} of 18.4% only).

TABLE 6
Summary of the results obtained at different T_{cut-off/chg}
during the charge phaseof the material Ceram9 at
moderately high temperatures (T_{H} around 520° C.)

| Parameter | Unit | Relevant temperature threshold | | |
|---|---|---|---|---|
| β | — | 0.2 | 0.4 | 0.6 |
| T_{cut-off/chg} | ° C. | 137.6 | 235.2 | 332.8 |
| η_{chg} | % | 67.2 | 79.0 | 86.4 |
| t_{breakpoint} | h | 2.21 | 2.73 | 3.27 |
| η_{wh} | % | 7.8 | 12.3 | 18.4 |

FIG. 17 and Table 7 show the results obtained during the discharge phase. The increase in discharge time leads to a consecutive drop in the output temperature and a consecutive increase in the level of discharge (cf. FIG. 17). After 3.9 h of discharge, 94.2% of the amount of heat stored was restored (Table 7). The results obtained for the two charge and discharge phases show that the studied material is efficient for the storage of sensible heat at moderately high temperatures.

TABLE 7
Summary of the results obtained at different T_{cut-off/dis} during
the discharge phase of the material Ceram9 at
moderately high temperatures (T_{H} around 520° C.)

| Parameter | Unit | Relevant temperature threshold | | |
|---|---|---|---|---|
| β | — | 0.2 | 0.4 | 0.6 |
| T_{cut-off/chg} | ° C. | 414.8 | 317.6 | 220.4 |
| η_{dis} | % | 72.2 | 88 | 94.2 |
| t_{breakpoint} | h | 2.77 | 3.5 | 3.9 |

### EXAMPLE 3

This test was carried out with the same material as that used for examples 1 to 2, but at high values of T_{H} (around 760° C.). Table 8 shows the conditions used.

TABLE 8
Test conditions for the material Ceram9
at high temperatures (T_{H} around 760° C.)

| Charge phase | | | Discharge phase | | |
|---|---|---|---|---|---|
| Material | Ceram9 | | Material | Ceram9 | |
| T_{H} | 775° | C. | T_{H} | 767° | C. |
| T_{L} | 27° | C. | T_{L} | 28° | C. |
| T_{amb} | 23° | C. | T_{amb} | 24° | C. |
| \dot{m} | 56.5 | kg/h | \dot{m} | 39.5 | kg/h |

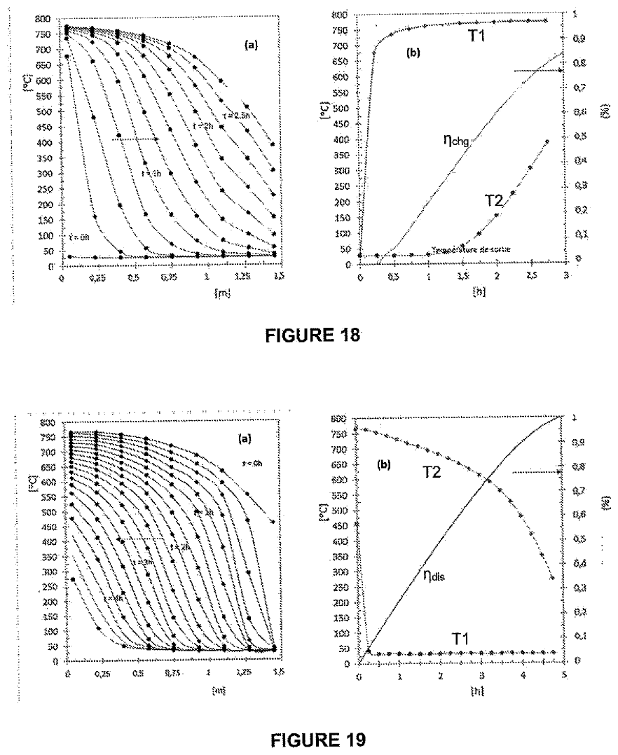

FIG. 18 and Table 9 show the results obtained for the charge phase. The input temperature rapidly stabilises around 760° C. after 60 min of charge. The output temperature remains close to ambient temperature during the first 60 min, then it begins to increase. The level of charge increases with the charge time and reaches 86.9% after 3.76 h. At this level of charge, thermal losses are relatively low (η_{wh} of 13.9% only).

TABLE 9
Summary of the results obtained at different T_{cut-off/chg}
during the charge phase of the material Ceram9
at high temperatures (T_{H} around 760° C.)

| Parameter | Unit | Relevant temperature threshold | | |
|---|---|---|---|---|
| B | — | 0.2 | 0.4 | 0.6 |
| T_{cut-off/chg} | ° C. | 176.6 | 326.2 | 475 .8 |
| η_{chg} | % | 70.2 | 81.2 | 87.2 |
| t_{breakpoint} | h | 2.35 | 2.83 | 3.25 |
| η_{wh} | % | 3.5 | 7.85 | 12.9 |

FIG. 19 and Table 10 show the results obtained for the discharge phase. The increase in discharge time is accompanied by a consecutive drop in the output temperature and a consecutive increase in the level of discharge (FIG. 19). After 4.58 h of discharge, 96.7% of the amount of heat stored was restored (Table 10). The results obtained for the two charge and discharge phases show that the studied material is efficient for the storage of sensible heat at high temperatures around 760° C.

TABLE 10
Summary of the results obtained at different T_{cut-off/dis}
during the discharge phase of the material
Ceram9 at high temperatures (T_{H} around 760° C.)

| Parameter | Unit | Relevant temperature threshold | | |
|---|---|---|---|---|
| B | — | 0.2 | 0.4 | 0.6 |
| T_{cut-off/chg} | °C | 618.8 | 471.1 | 323.4 |
| η_{dis} | % | 69.2 | 89.4 | 96.7 |
| t_{breakpoint} | h | 2.92 | 4.02 | 4.58 |

### EXAMPLE 4

This test was carried out with the ceramic Ceram35, which contains 5% by weight of PN, at moderate temperatures T_{H}. Table 11 summarises the conditions used for the charge and discharge phases.

TABLE 11
Test conditions for the material Ceram35 at moderate
temperatures (T_{H} around 350° C.)

| Charge phase | | | Discharge phase | | |
|---|---|---|---|---|---|
| Material | Ceram35 | | Material | Ceram35 | |
| T_{H} | 352° | C. | T_{H} | 349° | C. |
| T_{L} | 27° | C. | T_{L} | 31° | C. |
| T_{amb} | 26° | C. | T_{amb} | 31° | C. |
| \dot{m} | 74.8 | kg/h | \dot{m} | 74.8 | kg/h |

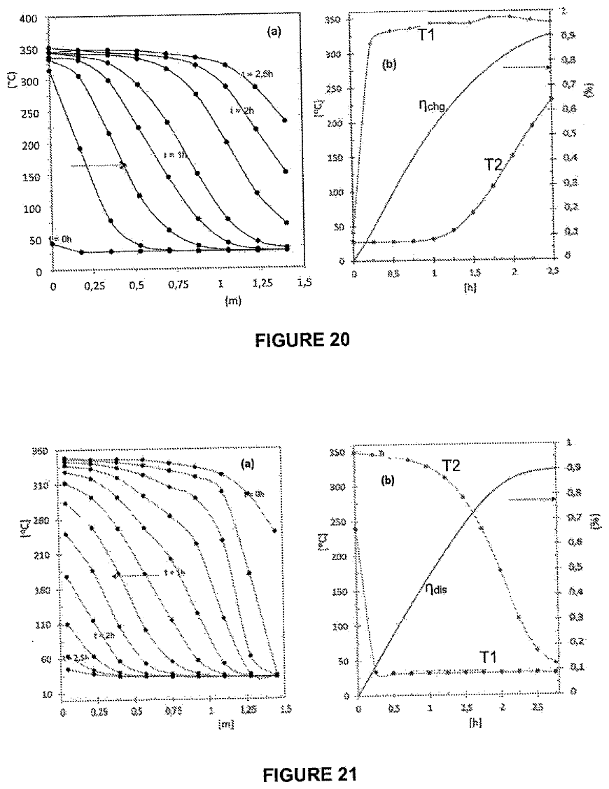

FIG. 20 and Table 12 show the results obtained for the charge phase. The input temperature rapidly stabilises around 340-350° C. after 30 min of charge. The outlet temperature remains close to ambient temperature for around 0.75 h then it begins to increase. The level of charge increases with charge time and reaches 89.9% after 2.43 h. At this level of charge, thermal losses are relatively low (η_{wh} of 14.6% only).

TABLE 12
Summary of the results obtained at different
T_{cut-off/chg} during the charge phase of the material
Ceram35 at high temperatures (T_{H} around 350° C.)

| Parameter | Unit | Relevant temperature threshold | | |
|---|---|---|---|---|
| B | — | 0.2 | 0.4 | 0.6 |
| T_{cut-off/chg} | ° C. | 92.2 | 157.0 | 222.0 |
| η_{chg} | % | 75.6 | 84.3 | 89.9 |
| t_{breakpoint} | h | 1.66 | 2.03 | 2.43 |
| η_{wh} | % | 3.6 | 8.1 | 14.6 |

FIG. 21 and Table 13 show the results obtained for the discharge phase. The increase in discharge time is accompanied by a consecutive drop in the output temperature and a consecutive increase in the level of discharge (FIG. 21). After 2.06 h of discharge, the level of discharge is 84.2% (Table 13). The material Ceram35 is thus efficient for the storage and the de-storage of sensible heat at moderate temperatures (around 350° C.).

TABLE 13
Summary of the results obtained at different T_{cut-off/dis}
during the discharge phase of the material Ceram35
at moderate temperatures (T_{H} around 350° C.)

| Parameter | Unit | Relevant temperature threshold | | |
|---|---|---|---|---|
| B | — | 0.2 | 0.4 | 0.6 |
| T_{cut-off/chg} | ° C. | 285.2 | 221.7 | 158.2 |
| η_{dis} | % | 67.1 | 78.5 | 84.2 |
| t_{breakpoint} | h | 1.48 | 1.82 | 2.06 |

### EXAMPLE 5

The test of this example was carried out with the material Ceram35 at moderately high temperatures (around 580° C.). Table 14 shows the conditions used for this test.

TABLE 14
Test conditions for the material Ceram35 at
moderately high temperatures(T_{H} around 580° C.)

| Charge phase | | | Discharge phase | | |
|---|---|---|---|---|---|
| Material | Ceram35 | | Material | Ceram35 | |
| T_{H} | 580° | C. | T_{H} | 578° | C. |
| T_{L} | 25° | C. | T_{L} | 30° | C. |
| T_{amb} | 24° | C. | T^{amb} | 29° | C. |
| \dot{m} | 52 | kg/h | \dot{m} | 52 | kg/h |

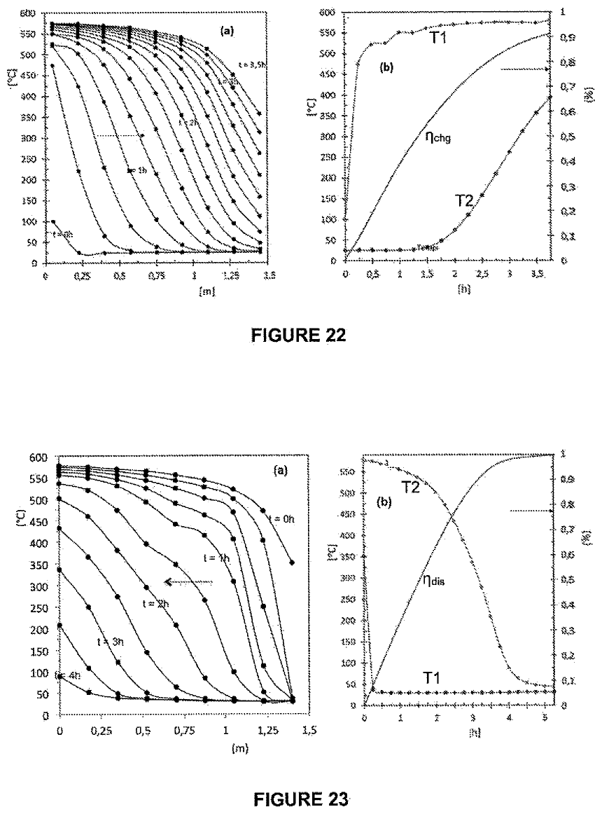

FIG. 22 and Table 15 show the results obtained for the charge phase. The input temperature rapidly stabilises around 550-580° C. after 60 min of charge. The output temperature remains close to ambient temperature for around 1.25 h then it begins to increase. The level of charge increases with charge time and reaches 89.6% after 3.50 h. At this level of charge, thermal losses are relatively low (η_{wh} of 14.0% only).

TABLE 15
Summary of the results obtained at different T_{cut-off/chg} during
the charge phase of the material Ceram35 at moderately
high temperatures (T_{H} around 580° C.)

| Parameter | Unit | Relevant temperature threshold | | |
|---|---|---|---|---|
| B | — | 0.2 | 0.4 | 0.6 |
| T_{cut-off/chg} | ° C. | 135.9 | 246.8 | 357.7 |
| η_{chg} | % | 75.8 | 84.1 | 89.6 |
| t_{breakpoint} | h | 2.38 | 2.92 | 3.50 |
| η_{wh} | % | 3.2 | 7.6 | 14.0 |

FIG. 23 and Table 16 show the results obtained for the discharge phase. The output temperature drops with charge time. At the same time, the level of discharge increases (FIG. 23). After 3.35 h of discharge, the amount of heat initially stored was discharged to a level of 92.8% (Table 16). These results show that the material Ceram35 is efficient for the storage and de-storage of sensible heat at moderately high temperatures (around 580° C.).

TABLE 16
Summary of the results obtained at different T_{cut-off/dis} during
the discharge phaseof the material Ceram35 at moderately
high temperatures (T_{H} around 580° C.)

| Parameter | Unit | Relevant temperature threshold | | |
|---|---|---|---|---|
| B | — | 0.2 | 0.4 | 0.6 |
| Tc_{ut-off/chg} | ° C. | 468.4 | 358.5 | 249.2 |
| η_{dis} | % | 70.9 | 85.2 | 92.8 |
| t_{breakpoint} | h | 2.27 | 2.89 | 3.35 |

### EXAMPLE 6

The same material used for examples 4 and 5 was tested at high temperatures (T_{H} around 850° C.). The experimental conditions of this test are summarised in Table 17.

TABLE 17
Test conditions for the material Ceram35 at high
temperatures (T_{H} around 850° C.

| Charge phase | | | Discharge phase | | |
|---|---|---|---|---|---|
| Material | Ceram35 | | Material | Ceram35 | |
| T_{H} | 855° | C. | T_{H} | 840° | C. |
| T_{L} | 29° | C. | T_{L} | 32° | C. |
| T_{amb} | 28° | C. | T_{amb} | 31° | C. |
| \dot{m} | 56.5 | kg/h | \dot{m} | 45.6 | kg/h |

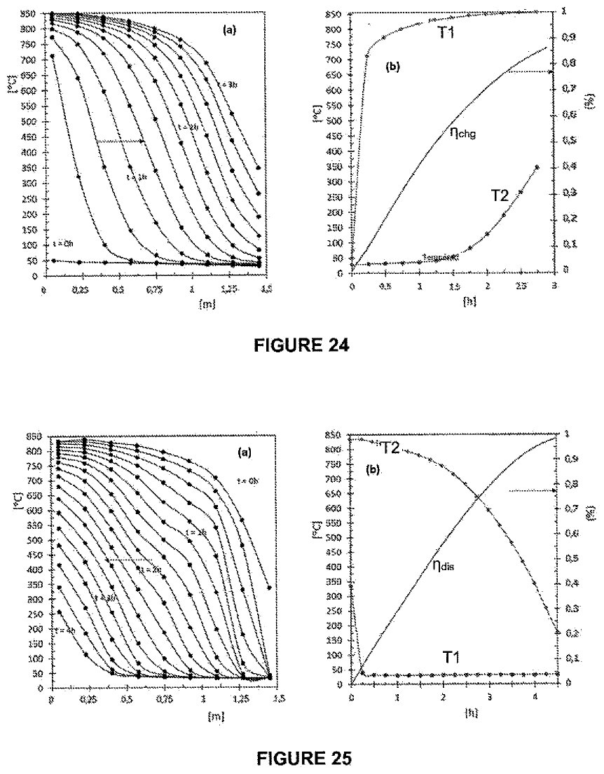

FIG. 24 and Table 18 show the results obtained for the charge phase. The input temperature stabilises around 800-850° C. after 45 min of charge. The output temperature is close to ambient temperature during around 1 h indicating that the totality of the heat injected has been absorbed by the material. Next, this output temperature begins to increase. The level of charge increases with charge time and reaches 86.3% after 2.91 h. At this level of charge, thermal losses are relatively low (η_{wh} of 8.9% only).

TABLE 18
Summary of the results obtained at different T_{cut-off/chg}
during the charge phase of the material
Ceram35 at high temperatures (T_{H} around 850° C.)

| Parameter | Unit | Relevant temperature threshold | | |
|---|---|---|---|---|
| B | — | 0.2 | 0.4 | 0.6 |
| T_{cut-off/chg} | ° C. | 194.2 | 359.4 | 524.6 |
| η_{chg} | % | 76.4 | 84.8 | 86.3 |
| t_{breakpoint} | h | 2.27 | 2.78 | 2.91 |
| η_{wh} | % | 3.5 | 7.6 | 8.9 |

FIG. 25 and Table 19 show the results obtained for the discharge phase. With charge time, the output temperature drops and at the same time the level of discharge increases (FIG. 25). After 3.95 h of discharge, 94% of the heat stored is restored (Table 19). These results show that the material Ceram35 is efficient for the storage and de-storage of sensible heat at high temperatures (T_{H} around 850° C.).

TABLE 19
Summary of the results obtained at different T_{cut-off/dis} during the discharge
phase of the material Ceram35 at high temperatures (T_{H} around 850 ° C.)

| Parameter | Unit | Relevant temperature threshold | | |
|---|---|---|---|---|
| B | — | 0.2 | 0.4 | 0.6 |
| T_{cut-off/chg} | ° C. | 678.4 | 516.8 | 355.2 |
| η_{dis} | % | 68.5 | 85.4 | 94.0 |
| _{tbreakpoint} | h | 2.51 | 3.34 | 3.95 |

Other storage and de-storage tests were carried out with the two materials Ceram9 and Ceram35 at different values of T_{H} and mass flow rate of the heat transfer fluid (air). Tables 20 and 21 summarise the experimental conditions and the main results obtained for these tests. Whatever the temperature T_{H} tested and at a given mass flow rate of the heat transfer fluid, the results are reproducible. At a given temperature T_{H}, the increase in the mass flow rate of the heat transfer fluid makes it possible to reduce the charge time to reach the same level of charge. This observation is similar for the discharge phase. For the charge phase, in all cases, thermal losses are relatively low (less than 19%). In other words, the materials used are efficient for the transfer of heat with the heat transfer fluid in the conditions used.

TABLE 20
Experimental conditions and main results for all of the charge and discharge
tests obtained with the ceramic Ceram9 (160 kg of ceramic, ceramic
in the form of cylinders of 15 mm diameter and 40 mm length).

| | | Mass flow | | β = 0.6 | | | | | |
|---|---|---|---|---|---|---|---|---|---|
| | | rate of air | T_{H} | T_{cut-off/chg} | T_{cut-off/dis} | t_{breakpoint} | η_{chg} | η_{dis} | η_{wh} |
| Test | Type | (kg/h) | (° C.) | (° C.) | (° C.) | (h) | (%) | (%) | (%) |

Charge: Moderate temperatures (T_{H} around 330-350° C.)

| | | | | | | | | | |
|---|---|---|---|---|---|---|---|---|---|
| 01 | Charge | 48 | 334 | 215.6 | — | 3.24 | 86.7 | — | 17.6 |
| 02 | Charge | 66.5 | 356 | 224.2 | — | 2.57 | 87.1 | — | 15.8 |
| 03 | Charge | 70 | 341 | 209 | — | 2.44 | 87.4 | — | 15.5 |
| 04 | Charge | 70 | 335 | 209 | — | 2.41 | 87.2 | — | 14.3 |
| 05 | Charge | 74 | 355 | 214.2 | — | 2.28 | 86.9 | — | 14.1 |

Charge: Moderately high temperatures (T_{H} around 530-550° C.)

| | | | | | | | | | |
|---|---|---|---|---|---|---|---|---|---|
| 06 | Charge | 49.5 | 531 | 329.4 | — | 3.46 | 87.1 | — | 14.3 |
| 07 | Charge | 53 | 528 | 332.8 | — | 3.27 | 86.4 | — | 18.4 |
| 08 | Charge | 55 | 554 | 345.1 | — | 3.14 | 88.1 | — | 14.6 |
| 09 | Charge | 64.5 | 540 | 334.4 | — | 2.79 | 88.0 | — | 14.1 |
| 10 | Charge | 65.5 | 538 | 331.6 | — | 2.70 | 87.8 | — | 14.2 |

Charge: High temperatures (T_{H} around 750-775° C.)

| | | | | | | | | | |
|---|---|---|---|---|---|---|---|---|---|
| 11 | Charge | 48 | 759 | 465.6 | — | 3.76 | 86.9 | — | 13.9 |
| 12 | Charge | 56.5 | 775 | 475.8 | — | 3.25 | 87.2 | — | 12.9 |

Discharge: Moderate temperatures (T_{H} around 330-350° C.)

| | | | | | | | | | |
|---|---|---|---|---|---|---|---|---|---|
| 13 | Discharge | 48 | 334 | — | 147.2 | 3.21 | — | 90.9 | — |
| 14 | Discharge | 74 | 340 | — | 150.4 | 2.28 | — | 93.6 | — |
| 15 | Discharge | 70 | 335 | — | 146.0 | 2.34 | — | 90.7 | — |
| 16 | Discharge | 70 | 338 | — | 148.4 | 2.42 | — | 92.7 | — |
| 17 | Discharge | 104 | 343 | — | 157.7 | 1.51 | — | 91.5 | — |

Discharge: Moderately high temperatures (T_{H} around 530-550° C.)

| | | | | | | | | | |
|---|---|---|---|---|---|---|---|---|---|
| 18 | Discharge | 26.5 | 547 | — | 235.9 | 6.47 | — | 90.3 | — |
| 19 | Discharge | 38.5 | 530 | — | 229.4 | 4.62 | — | 94.4 | — |
| 20 | Discharge | 48 | 512 | — | 220.4 | 3.9 | — | 94.2 | — |
| 21 | Discharge | 56 | 531 | — | 229.9 | 3.1 | — | 91.2 | — |
| 22 | Discharge | 100.8 | 537 | — | 231.8 | 1.75 | — | 94 | — |

Discharge: High temperatures (T_{H} around 750-770° C.)

| | | | | | | | | | |
|---|---|---|---|---|---|---|---|---|---|
| 23 | Discharge | 39.5 | 767 | — | 323.4 | 4.58 | — | 96.7 | — |
| 24 | Discharge | 41.5 | 752 | — | 544.1 | 3.6 | — | 86.2 | — |

TABLE 21
Experimental conditions and main results for all of the charge and discharge
tests obtained with the ceramic Ceram35 (160 kg of ceramic, ceramic
in the form of cylinders of 15 mm diameter and 40 mm length)

| | | Mass flow | | β = 0.6 | | | | | |
|---|---|---|---|---|---|---|---|---|---|
| | | rate of air | T_{H} | T_{cut-off/chg} | T_{cut-off/dis} | t_{breakpoint} | η_{chg} | η_{dis} | η_{wh} |
| Test | Type | (kg/h) | (° C.) | (° C.) | (° C.) | (h) | (%) | (%) | (%) |

Charge: Moderate temperatures (T_{H} around 350° C.)

| | | | | | | | | | |
|---|---|---|---|---|---|---|---|---|---|
| 25 | Charge | 52 | 352 | 222 | — | 3.27 | 88.1 | — | 12.0 |
| 26 | Charge | 74.8 | 352 | 222 | — | 2.43 | 89.9 | — | 14.6 |

Charge: Moderately high temperatures (T_{H} around 580° C.)

| | | | | | | | | | |
|---|---|---|---|---|---|---|---|---|---|
| 27 | Charge | 52 | 580 | 357.7 | — | 3.50 | 89.6 | — | 14.0 |
| 28 | Charge | 63.7 | 579 | 357.8 | — | 2.80 | 89.6 | — | 14.7 |

Charge: High temperatures (T_{H} around 850° C.)

| | | | | | | | | | |
|---|---|---|---|---|---|---|---|---|---|
| 29 | Charge | 49.6 | 848 | 520.4 | — | 3.36 | 86.7 | — | 8.2 |
| 30 | Charge | 56.5 | 855 | 524.6 | — | 2.91 | 86.3 | — | 9.0 |

Discharge: Moderate temperatures (T_{H} around 350° C.)

| | | | | | | | | | |
|---|---|---|---|---|---|---|---|---|---|
| 31 | Discharge | 52 | 351 | — | 157.6 | 2.99 | — | 87.9 | — |
| 32 | Discharge | 74.8 | 349 | — | 158.2 | 2.06 | — | 84.2 | — |

Discharge: Moderately high temperatures (T_{H} around 570° C.)

| | | | | | | | | | |
|---|---|---|---|---|---|---|---|---|---|
| 33 | Discharge | 52 | 578 | — | 249.2 | 3.35 | — | 92.8 | — |
| 34 | Discharge | 63.3 | 573 | — | 246 | 2.74 | — | 93.8 | — |

Discharge: High temperatures (T_{H} around 840° C.)

| | | | | | | | | | |
|---|---|---|---|---|---|---|---|---|---|
| 35 | Discharge | 45.6 | 840 | — | 355.2 | 3.95 | — | 94.0 | — |
| 36 | Discharge | 65.5 | 843 | — | 353.7 | 2.70 | — | 92.9 | — |

### REFERENCES

[1] Kuravi S., Trahan J., Goswami D. Y., Rahman M .M., Stefanakos E. K. Thermal energy storage technologies and systems for concentrating solar power plants. Progress in Energy and Combustion Science 39 (2013) 285-319.

[2] Dintera, F., Gonzalez, D. M. Operability, reliability and economic benefits of CSP with thermal energy storage: first year of operation of ANDASOL 3. Energy Procedia 49 (2014) 2472-2481.

[3] Rellosoa, S., Garcia, E. Tower technology cost reduction approach after Gemasolar experience. Energy Procedia 69 (2015) 1660-1666.

[4] D. Laing and S. Zunft. 4—Using concrete and other solid storage media in thermal energy storage (TES) systems. Advances in Thermal Energy Storage Systems, pp 65-86. Woodhead Publishing, 2015.

[5] Murray H., Applied clay mineralogy, 1^{st} Edition, Elsevier Science, 2007 (Hardcover ISBN: 9780444517012).

1. A method for manufacturing a ceramic material for thermal energy storage, comprising:
producing a mixture of at least particles of clay and particles of natural and/or synthetic phosphate, and water, said mixture comprising between 0.5% and 40% by weight of phosphate compared to the weight of the mixture with the exception of water, and firing said mixture to obtain the ceramic material.

2. The method of claim 1, wherein the mixture comprises between 4% and 5% by weight of phosphate compared to the weight of the mixture with the exception of water.

3. The method of claim 1, wherein the mixture comprises between 50 and 90% by weight of clay, preferably between 60 and 80% by weight.

4. The method of claim 1, wherein the average size of the clay and phosphate particles is less than 1 mm.

5. The method of claim 1, wherein the mixture further comprises up to 40% by weight of sand particles, preferably between 10 and 30% by weight.

6. The method of claim 5, wherein the average size of the sand particles is less than 1.5 mm.

7. The method of claim 1, further comprising the shaping of the ceramic material by one of the following techniques: extrusion, granulation, moulding, compacting or pressing of the mixture.

8. The method of claim 1, further comprising, after the shaping step, the drying of the ceramic material at a temperature less than or equal to 105° C.

9. The method of claim 8, wherein the firing of the ceramic material is carried out at a temperature comprised between 800 and 1200° C., preferably between 900 and 1150° C.

10. A ceramic material for thermal energy storage, comprising
a matrix of clay and, if appropriate, sand, and
particles of a natural and/or synthetic phosphate dispersed in said matrix,
said ceramic material comprising between 0.5% and 40% by weight of phosphate compared to the weight of the ceramic material.

11. The ceramic material of claim 10, being in the form of a cylinder, a sphere, a cube, a spiral, a flat plate, a corrugated plate, a hollow brick or a Raschig ring.

12. A method for storing thermal energy in a ceramic material, comprising placing a heat transfer fluid in contact with the ceramic material of claim 10, so as to transfer heat from the heat transfer fluid to the ceramic material in a charge phase, and to transfer heat from the ceramic material to the heat transfer fluid in a discharge phase.

13. The method of claim 12, wherein the ceramic material is contained in a tank.

14. The method of claim 13, wherein the tank is formed of at least one thermally insulating material.

15. The method of claim 12, wherein the heat transfer fluid is selected from air, water vapour, an oil or a molten salt.

16. The method of claim 12, wherein, during the charge phase and/or the discharge phase, the heat transfer fluid is at a temperature comprised between 20 and 1100° C.

17. A thermal energy storage device for the implementation of the method according to claim 12, comprising a tank containing the ceramic material and a heat transfer fluid circulation circuit in fluidic connection with the tank so as to place said heat transfer fluid in contact with the ceramic material.
